(19) United States
(12) Patent Application Publication
(10) Pub. No.: US 2005/0161137 A1
(43) Pub. Date: Jul. 28, 2005

(54) Method for air pressure regulation and improved aesthetics in automobile wheels

(76) Inventor: Quyen Cao Hoang, Westminster, CA (US)

Correspondence Address: Quyen C. Hoang, 6174 Westbridge Ave., Westminster, CA, 92683, US

(21) Appl. No.: 10/766,051

(22) Filed: Jan. 28, 2004

(51) Int. Cl. B60C 23/10

(52) U.S. Cl. 152/415

(57) ABSTRACT

An air pressure regulation apparatus of the type suitable for use in an automobile wheel and comprising an air valve and stem 1 and an air valve chamber 2 located substantially centered about the hub 3 of the wheel. The hub 3 is connected to the rim 7 of the wheel by spokes 4 wherein an inflation air corridor 5 is embedded or otherwise hidden from view from the street side of the wheel by said spoke. The air valve and stem 1 is connected to the inflation air corridor 5, which terminates at the inflation air nozzle 6. Said nozzle is located at a predetermined point between the lips 9 of the wheel. Operation of the wheel of the present invention is thus, inflation air is introduced at the air valve and stem 1. Said air then travels through said air corridor 5 and exits through said inflation nozzle 6 into the tire thereby creating sufficient air pressure to inflate said tire. Whereby, said air pressure regulation can occur in said wheel without the aesthetic drawbacks of the prior art as herein mentioned.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

1. Field of the Invention

This invention relates generally to wheels for automobiles.

2. Discussion of Background

While the current generation of automobile wheels work efficiently, the market for wheels with combined performance and aesthetic characteristics are greater than ever. Existing wheels, especially those for high-end vehicles however have the same aesthetic drawbacks as the common wheels of economy cars, specifically the tire air-valve stem that protrudes from the automobile wheels. Said tire valve stem and the port in the wheel that accommodates it create an interruption in the visual flow of the wheel and an unattractive diversion from the design aesthetics of the wheel itself. Both the common black color and the plastic material contributes to the break in the design as it takes away from smoothness and sheen of the wheels, both of which principally contributes to the aesthetics of the wheels.

Furthermore, valve stems on expensive automobile wheels try to compensate for the disruption of the design and material consistency of said wheel by placing shiny metallic caps on said valve stems. Although, this measure may slightly improve the looks of the wheel, it's major drawback is that said valve stem caps are often lost and or stolen.

Lastly, the wheel/tire inflation system of the current design also creates a significant week point in the integrity of the tire. Specifically, the valve stem is unprotected and easily accessible thereby making it possible for the tires to be deflated via actuation of the valve stem or by forcefully pulling the valve stem from the tire.

What is required is a wheel that accommodates an air valve stem to inflate the tires without creating the aesthetic and functional drawbacks herein mentioned.

### SUMMARY OF THE INVENTION

One object of this invention is to provide a wheel that accommodates the tire air valve stem in a manner that does not negatively impact the design aesthetics of the wheel itself as herein mentioned.

Another object of the invention is to create a robust tire inflation system that does not create a week point in the tire as compared to existing methods wherein tire deflation may result from unauthorized access to the valve stem as herein mentioned.

Another object of the invention is to create a practical method of modifying existing wheels to integrate the tire inflation system as described herein.

A feature of the invention is that the tire air-valve stem is located in the center of the hub of the wheel in front of the spindle mount.

Another feature of the invention is that the air valve is connected to an inflation air corridor that terminates in an inflation air nozzle used to inflate the tire with said air valve shrouded in an air-valve chamber that can be hidden from view.

Another feature of the invention is that said inflation air corridor is hidden behind, embedded in or other wise obfuscated by the spoke of the wheel.

The essential advantage of the invention therefore lies in the ability to create a wheel that has the same functionalities of current wheels but provides opportunities for increased aesthetics and protection of the air-valve and stem over the prior art.

### BRIEF DESCRIPTION OF THE DRAWING

A more complete appreciation of the invention and many of the attendant advantages thereof will be readily obtained as the same becomes better understood by reference to the following detailed description when considered in connection with the accompanying drawings, wherein:

FIG. 1 shows a cut away view of a wheel of the present invention wherein the air valve and stem are located at the hub with the top of the picture representing the street side of the wheel; and

FIG. 2 shows a top (street side) view of a wheel of the present invention wherein the air valve and stem are located at the hub; and

FIG. 3 shows a cross section of a spoke of the present invention.

### DESCRIPTIONS OF THE PREFERRED EMBODIMENTS

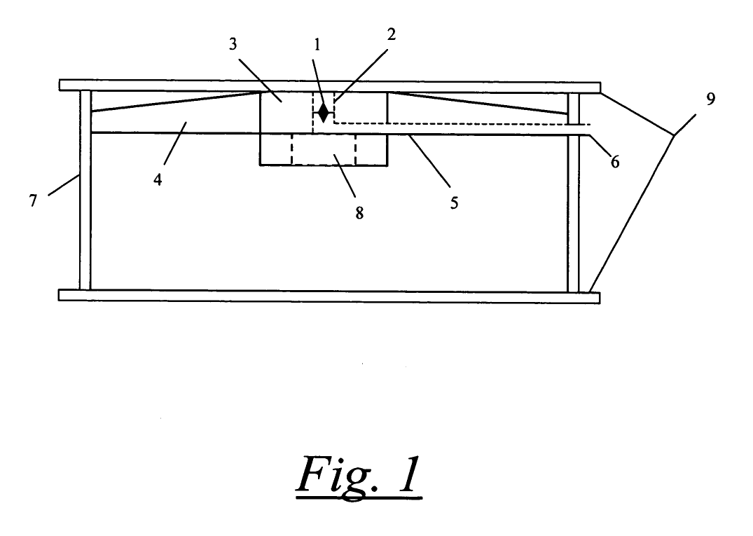

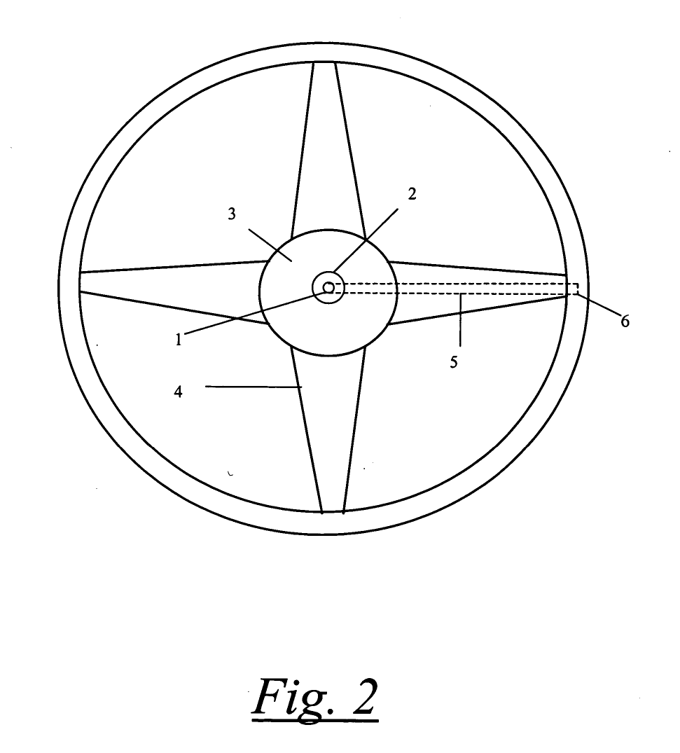

Referring now to the drawings, like reference numerals designate identical or corresponding parts throughout the several views, all elements not required for directly understanding the invention have been omitted. FIG. 1 and FIG. 2 depicts a wheel of the present invention wherein the air valve and stem are located centrally at the hub of the wheel and comprising an air valve and stem 1 and an air valve chamber 2 located at the center of the hub 3 of the wheel. In this embodiment of the present invention, the spindle mount 8 does not pass entirely through the hub, but only a portion thereof on the break and caliper side of the wheel. The hub 3 is connected to the rim 7 of the wheel by spokes 4 wherein an inflation air corridor 5 is hidden behind or otherwise obfuscated from view from the street side of the wheel by said spoke. The air valve and stem 1 is connected to at least one inflation air corridor 5 which then terminates at the inflation air nozzle 6 which is located at a predetermined point between the lips 9 of the wheel.

Operation of the wheel of the present invention is thus, inflation air is introduced at the air valve and stem 1. Said air then travels through said air corridor 5 and exits through said inflation nozzle 6 into the interior of the tire mounted on the wheel thereby creating sufficient air pressure to inflate said tire.

The preferred embodiment of the present invention regarding the air valve and stem 1 is that it is of a compact and metallic design. Furthermore said valve and stem 1 would also have a male threaded joining feature in which it can attach to and be removed from the inflation system described herein, particularly the air valve chamber 2. Thusly, air valve chamber 2 would have a female threaded joining feature to receive the corresponding male threaded air valve and stem 1. Also, by being threadedly joined in this manner, the air valve and stem need only be replaced periodically over the life of the wheel as compared to the prior art wherein every time a tire is changed the air valve and stem would necessarily have to be replaced. Furthermore, the preferred embodiment of the present invention is that the air valve and stem 1 is housed in and operatively connected to the air valve chamber 2 which is located in front of the spindle mount/wheel axle with said air valve chamber 2 covered by a locking decorative cap or lid.

The prior art that discloses wheels with inflation air passageways integrated with the spoke of said wheels are numerous. For example, from German Patent Document DE-41 03 644 A1, a wheel is disclosed which has a tire inflation valve close to the wheel axle with inflation air traveling from the valve to the tire via an interior passageway integrated in the wheel spoke. Similarly, U.S. Pat. No. 5,313,996 (Bragg patent) discloses a similar method to inflate a tire via an air passageway integrated in said spoke. Additionally, in U.S. Pat. No. 5,641,208 (Stach patent) a method of inflating a tire is disclosed using a plurality of hollow spokes in a wheel. The present invention can be distinguished over the aforementioned prior art specifically in disclosed preferred embodiment of an inflation air valve connected to an inflation air chamber, which is centrally located in the hub in front of and covering the spindle mount/wheel axle. The Bragg, Stach, and aforementioned German patent all disclose an inflation air valve placement that is adjacent to the wheel mounting bolt holes. The placement of the air valve as disclosed in the prior art imposes certain limitations that make them impractical. Specifically, wheel-mounting bolt holes are normally evenly spaced. Placing the tire valve adjacent to said bolt holes as proposed by the prior art, creates an unsightly uneven grouping of holes near the hub of the wheel. Although this drawback is addressed by the Bragg patent through the use of a decorative cap or lid that covers the entire hub area. It should be noted that the above referenced German patent as well as the Stach patent similarly discloses use of a cap/lid to address said aesthetic drawback. This solution however is limited, as many popular wheel designs have exposed wheel bolt holes. The present invention properly addresses this limitation of the prior art by locating the tire valve in the center of the wheel hub in front of and covering the spindle mount/wheel axle.

Another limitation of the aforementioned patents is the use of an integrated air passageway in the wheel spoke. In the aforementioned German patent and the Bragg patent the air passageway is integrated in the wheel spoke as a hole that is bored therethrough and envisions an inflation air passageway that is bounded on all sides by the wheel material. In the Stach patent a plurality of hollow spokes is formed by welding a hollow structure onto a wheel to form the inflation system. The patent drawbacks of said prior art is that it envisions a design that is intended for use in the manufacture of new wheels. The complexity of the method of manufacturing said wheels with it's resulting consequence on costs is another drawback. Moreover, the designs of the prior art do not lend itself to being applied to existing wheels. Specifically, modifying existing wheels to adopt the inflation system of the prior art would involve complex and costly welding and drilling procedures that makes it impractical.

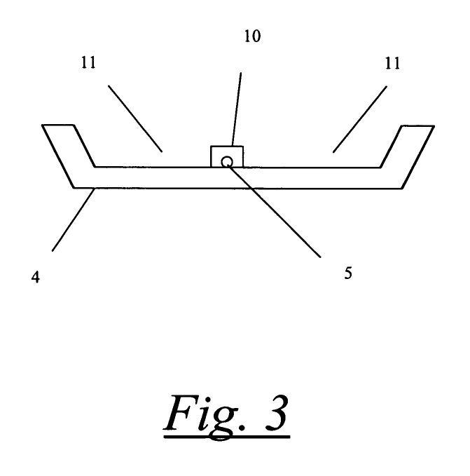

The disclosure of the present invention offers greater flexibility in the manufacture of a wheel spoke integrated tire inflation systems as well as modifications of existing wheels to implement said inflation system. Specifically, the present invention allows for wheels to be made with such an inflation system without significant changes in the manufacturing process. For example a wheel can be made with cast or machined grooves on the break side of the wheel spoke. Prefabricated tubing can then be placed in said groove and simply welded or otherwise secured to the wheel thus forming the inflation air corridor. Weights can also be welded onto the corresponding grooves to balance out the wheel. In fact, many existing wheels are manufactured with large grooves on the break caliper side of the wheel to remove mass therefrom and consequently create a lighter wheel. FIG. 3 shows a cross section of a wheel spoke of the present invention wherein the wheel spoke 4 has grooves 11 on the break caliper side of the wheel spoke 4. A prefabricated tube 10 with a hollow passageway provided there through forms the inflation air corridor 5. The design of the present invention would allow those skilled in the art to take advantage of said mass displacement grooves to house a prefabricated inflation air corridor with minimal modifications.

The invention has been described in an illustrative manner, and it is to be understood that the terminology, which has been used, is intended to be in the nature of words of description rather than of limitation. Obviously, numerous modifications and variations of the present invention are possible in light of the above teachings. It is therefore understood that within the scope of the appended claims, the invention may be practiced otherwise than as specifically described herein.

1-9. (canceled)

10. A vehicle wheel, comprising:
a. an air valve and stem located at the center of the hub of said wheel so as to be situated substantially in front of and substantially covering the wheel spindle mount as viewed from the perspective of the street side of the wheel,
b. said air valve and stem are in operative and flow communication with at least one inflation air corridor that terminates in an inflation air nozzle,
c. said inflation air corridor is of a predetermined length and is situated in a predetermined location about the wheel spoke so as to be hidden from view from the street side of the wheel,
d. said inflation air nozzle is located at a predetermined area between the lips of the wheel,
whereby air can be introduced into the interior region of a tire mounted on the wheel,
whereby, the air pressure of the tire can be controlled through an inflation system that is hidden from view and is thus more aesthetically pleasing and also limits unwanted access to said inflation system.

11. A wheel as claimed in claim 10, wherein the air valve and stem is housed in and connected to an air valve chamber in physical, operative and flow communication with at least one inflation air corridor.

12. A wheel as claimed in claim 1 1, wherein said air valve chamber is covered by a decorative cap or lid.

13. A wheel as claimed in claim 12, wherein the air valve chamber has a threaded joining feature at a predetermined area to receive a correspondingly threaded air valve and stem.

14. A wheel as claimed in claim 13, wherein said threaded joining feature of the air valve chamber is a female threaded joining.

15. A wheel as claimed in claim 13 wherein said correspondingly threaded air-valve and stem has a male threaded joining feature located at a predetermined area about the air-valve and stem to join with the female threaded joining feature of the air valve chamber.

16. The air valve and stem as claimed in claim 11 wherein said air-valve and stem are of a compact design and metallic in composition.

17. A wheel as claimed in claim 11 wherein the inflation air corridor is formed by a hollow tube secured in a groove which is located at a predetermined area on the break caliper side of the wheel spoke with said hollow tube connected to and in flow communication with the air valve chamber and inflation air nozzle.

18. A method for inflating and regulating pressure in the interior region of a tire mounted on the rim of a motor vehicle wheel in an optimally aesthetic manner, comprising:
(a) providing an air pressure regulating means located at a predetermined point about the center of the hub of said wheel so as to be situated substantially in front of and substantially covering the wheel spindle mount as viewed from the perspective of the street side of the wheel,
(b) providing at least one air communication means of a predetermined length physically and operatively connected to said air pressure regulating means to transfer air into and out of the interior region of a tire mounted on the wheel rim with said air communication means formed by a prefabricated hollow tube of a predetermined material.
(c) providing at least one groove which is located at a predetermined area on the break caliper side of the wheel in which to house the air communication means,
(d) providing an attachment means to securely attach said air communication means within said groove,
(e) providing an inflation air ingress and egress means at a predetermined point on said air communication means with said ingress/egress means situated at a predetermined point between the lips of the wheel,
(f) providing corresponding grooves of a predetermined proportion and dimension on at least one of the remaining spokes so as to keep the wheel in a properly balanced condition,
whereby air can be introduced into the interior region of a tire mounted on the wheel through an air-valve and stem located about the hub of the wheel,
whereby, said air pressure regulation can occur in said wheel without the aesthetic drawbacks of the prior art as herein mentioned,
whereby, existing wheels can be more easily modified to implement the wheel integrated tire air pressure regulation system over the prior art as herein mentioned,
whereby, said wheel integrated tire air pressure regulation system can be more easily made without significant additional procedures in the manufacturing process as compared to the prior art as herein mentioned.
